(19) United States
(12) Patent Application Publication
(10) Pub. No.: US 2010/0136298 A1
(43) Pub. Date: Jun. 3, 2010

(54) MARKING PLATE AND PROCESS FOR MANUFACTURING SUCH A PLATE

(76) Inventors: Jacques Marion, Saint Jean-sur-Veyle (FR); Jacques Spicq, Les Portes En Re (FR)

Correspondence Address: 3M INNOVATIVE PROPERTIES COMPANY, PO BOX 33427, ST. PAUL, MN, 55133-3427, US

(21) Appl. No.: 12/444,321

(22) PCT Filed: Oct. 2, 2007
(86) PCT No.: PCT/FR2007/001608

§ 371 Date: Feb. 5, 2010

(30) Foreign Application Priority Data
Oct. 3, 2006 (FR) 06 08656

(51) Int. Cl. B32B 3/28; B32B 3/10; B29C 59/02; B32B 38/06; B32B 38/10

(52) U.S. Cl. 428/187; 428/195.1; 264/134; 156/220

(57) ABSTRACT

This marking plate, which can be a license plate or a signage plate, comprises at least one base plate and symbols obtained by stamping the marking plate. The base plate is composed of a composite material containing a matrix and a fiber reinforcement comprising natural fibers.

### TECHNICAL FIELD

The present disclosure relates to a marking plate comprising at least one base plate and symbols obtained by stamping the marking plate, and to a process for manufacturing such a marking plate.

### BACKGROUND

Manufacturing a vehicle license plate by stamping an aluminum plate, so as to form raised characters on the plate, is known. Such a license plate can be single-type or double-type. A single-type plate comprises a single aluminum base plate, onto which the characters are formed by embossing. A double-type plate comprises a base plate and a thin surface plate, both made of aluminum and joined together. Characters are formed by stamping the double plate so that the thin plate, which carries the background color of the plate, is cut out at the position of the characters to let the color of the base plate appear. Where each character is cut out, the base plate interlinks with the thin plate and joins together by gripping, which contributes in the assembly of the thin plate on the surface of the base plate. The mechanical characteristics of aluminum plates can be easily adapted to obtain optimal embossing or stamping quality. However, aluminum is a material for which manufacturing and recycling take a lot of energy. This means that this material has a fluctuating and relatively high cost, which contributes to increasing the manufacturing and retreatment cost of aluminum marking plates.

Moreover, from EP-A-0 319 589, manufacturing interior accessories for automotive vehicles, such as dashboards or seat backs, in composite material is known. These accessories can in particular be obtained by stamping a plate made of composite material. These accessories do not carry symbols obtained by stamping, so differ from a marking plate, and this document does not cover the legibility of such symbols.

### SUMMARY

It is the drawbacks described above that the present disclosure addresses by proposing a marking plate having improved symbol marking quality, while having decreased manufacturing cost and good recyclability characteristics.

The present disclosure relates to a marking plate, for example, a license plate or a signage plate, including at least one base plate and symbols obtained by stamping the marking plate. The base plate includes a composite material containing a matrix and fiber reinforcement including natural fibers.

Specialized marking plate manufacturers have, until now, felt that fibrous materials do not deliver adequate embossing or stamping quality for the symbols on the plate using medium stamping force, similar to the force applied to stamp aluminum plates. Such a prejudice lies in a composite material having higher mechanical strength in deformation as compared to a metal, strength that is given by the fibers and at first seems incompatible with stamping sharp symbols on the plate, and in particular incompatible with cutting and gripping for a double-type plate.

Now, in a surprising way, the inventors of the present disclosure have shown that good quality stamping can be achieved with a plate, such that sharp and clearly visible characters or shapes are formed on the plate.

According to other advantageous features of the present disclosure, taken in isolation or according to all the technically possible combinations, (1) the composite material matrix is a thermoplastic or thermohardening resin, such as for example a polyester resin, an epoxy resin or a phenolic resin; (2) the fiber reinforcement of the composite material comprises sisal, hemp, linen, jute, wood, cotton, broom and/or raffia fibers; and/or (3) the matrix is made of polypropylene and the fiber reinforcement comprises sisal fibers.

According to a first embodiment, the plate is single-type, and the base plate includes a background coating, symbols (obtained, for example, by stamping the base plate), and colored stamped areas.

According to another embodiment, the plate is double-type and comprises a thin surface plate that is joined together with the base plate. The thin plate includes a background coating for the marking plate and symbols (obtained, for example, by stamping the marking plate and removing the cut-outs from the thin plate).

In some embodiments, the thin plate is composed of a composite material containing a matrix and a fiber reinforcement comprising natural fibers. In other embodiments, the thin plate is composed of a composite material containing the same type of matrix and natural fibers as the composite material composing the base plate, but in different proportions, so that the elongation coefficient of the thin plate is lower than the elongation coefficient of the base plate.

The present disclosure also describes the use of at least one composite material containing a matrix and a fiber reinforcement comprising natural fibers for manufacturing a marking plate.

The present disclosure also describes a process for manufacturing a single-type marking plate as described herein before, comprising: (1) forming a base plate draft from the fiber reinforcement and the matrix of composite material; (2) cutting a base plate out of the base plate draft; (3) coating the base plate or the base plate with a background coating; and (4) stamping the base plate.

Moreover, the present disclosure describes a process for manufacturing a double-type marking plate as described herein before, comprising: (1) preparing a base plate draft is prepared from the fiber reinforcement and the matrix; (2) preparing a thin plate draft from the fiber reinforcement and the matrix that compose the thin plate; (3) cutting the base plate out of the base plate draft; (4) cutting the thin plate out of the thin plate draft; (5) coating the thin plate draft or the thin plate with a background coating; (6) coating the base plate draft or the base plate with a coating; (7) joining together the base plate and the thin plate; (8) stamping the marking plate; and (9) removing the cut-outs from the thin plate.

### BRIEF DESCRIPTION OF DRAWINGS

The features and benefits of the present disclosure will appear in the description that follows of two embodiments of a marking plate according to the present disclosure, given only as examples and made in reference to the appended diagrams in which:

FIG. 1 is a front elevation view of a marking plate in accordance with a first embodiment of the present disclosure;

FIG. 2 is a partial cross-section on a larger scale along the II-II axis of FIG. 1;

FIG. 2A is a larger scale view of detailed part HA in FIG. 2;

FIG. 3 is an cross-section analogous to FIG. 2 for a marking plate in accordance with a second embodiment of the present disclosure; and

FIG. 3A is a larger scale view of detailed part IIIA in FIG. 3;

### DETAILED DESCRIPTION

A marking plate can be a vehicle license plate or any other visual marking plate, such as a road sign plate or a similar sign plate. The symbols carried by such a marking plate can comprise characters and shapes that can be figures but need not be. Furthermore, stamping is understood to mean any operation that permanently deforms the marking plate, including embossing and stamping.

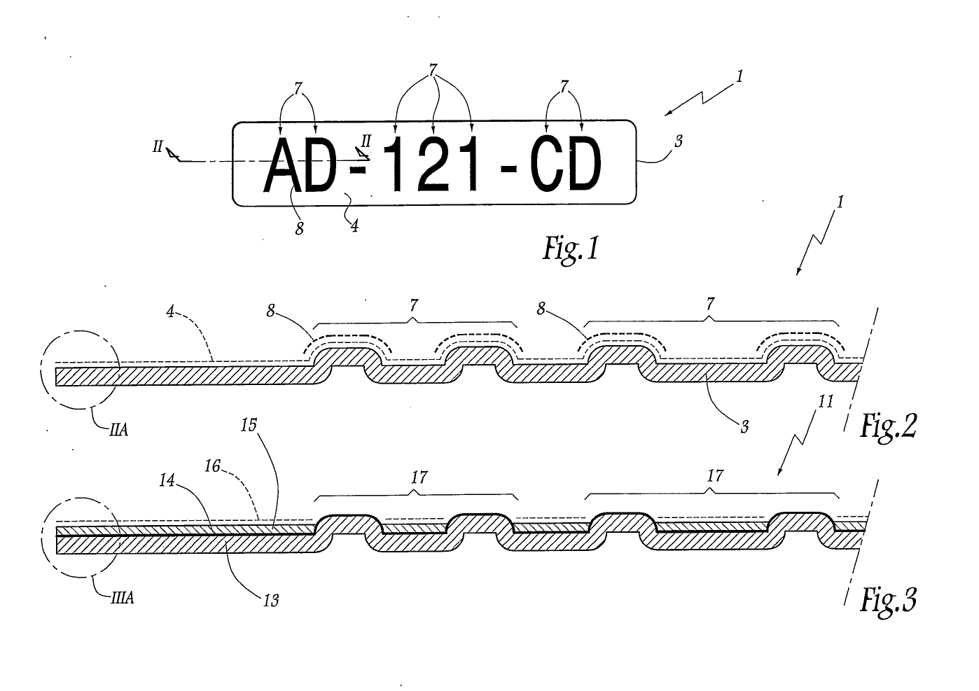

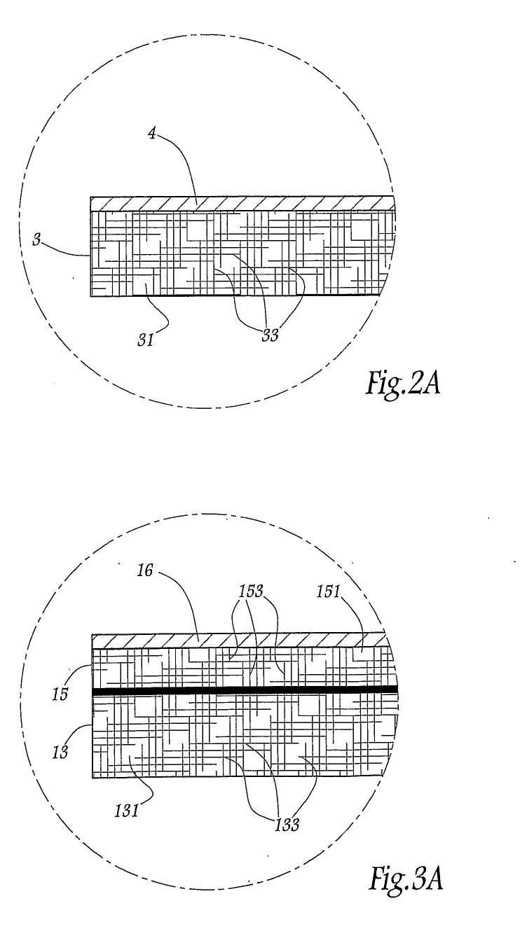

Marking plate 1 represented in FIGS. 1 and 2 is a single-type license plate, comprising a base plate 3 and license characters 7 obtained by embossing plate 1 using a set of complementary punches and matrices in the shape of each of characters 7.

Base plate 3 is the visible background of license plate 1 and is provided with a plate background coating 4, such as, for example, a lacquer or a retro-reflective film. Furthermore, each embossed character 7 is provided with a coating 8 having a different nature and color than coating 4, such as, for example, an ink or a paint. Coatings 4 and 8 may have photometric and colorimetric characteristics in accordance with the current regulations for license plates.

Base plate 3 is composed of a composite material containing a synthetic, artificial, or natural matrix 31 and a fiber reinforcement 33 comprising natural fibers. Artificial resin is understood to mean a resin obtained by transforming a natural compound. In this exemplary embodiment, base plate 3 is composed of polypropylene loaded with 30% sisal fibers, with dimensions in accordance with regulations and a plate thickness of 1 mm. More generally, base plate 3 can have a thickness comprised between 0.6 mm and 5 mm, preferably a thickness on the order of 1 mm.

Alternatively, matrix 31 of the composite material composing base plate 3 can be made of any type of synthetic or natural resin suitable for its function, such as, for example, a thermoplastic or thermohardening resin, in particular a polyester resin, an epoxy resin, a phenolic resin, etc. Additionally, fiber reinforcement 33 of the composite material composing base plate 3 may comprise other types of natural fibers suited to this use, such as, for example, hemp, linen, jute, wood, cotton, broom, raffia, etc., fibers or a mixture of these fibers. Alternatively, fiber reinforcement 33 can comprise natural fibers in combination with synthetic fibers, such as glass, carbon, or aramide fibers.

The percentage of fibers present in the composite material composing base plate 3 is adapted to obtain optimal embossing quality for characters 7. In an advantageous way, the composite material composing base plate 3 permits embossing plate 1 using tools normally used to manufacture a single-type aluminum license plate.

In practice, the percentage of fibers in the material composing the plate 3 ranges between 15% and 75%, preferably between 30% and 60%.

One exemplary process for manufacturing marking plate 1 comprises the following steps:

Firstly, a draft is prepared for base plate 3. In one embodiment, polypropylene and sisal fibers are mixed in suitable proportions, polypropylene being softened by heating to a temperature T greater than its softening point. The mixture obtained is injected into a mold with a desired shape, at temperature T, then cooled from temperature T to room temperature, so as to form a rigid draft plate approximately 1 mm thick.

Alternatively, the draft plate can be manufactured from sisal material, this material being placed into the mold before injecting the softened polypropylene. The draft plate can also be prepared by any other process for manufacturing plates of composite material, in particular by extrusion, lamination, etc.

Base plate 3 is then cut out of the draft plate, at the lengths and widths desired for license plate 1, and the edges of base plate 3 are shaped using the current practices for manufacturing single-type license plates. Next base plate 3 obtained is coated with background coating 4 for license plate 1. Alternatively, background coating 4 can be affixed to the draft plate before cutting one or more base plates from the draft. Base plate 3 is then embossed using a set of punches and matrices that complement the shape of each of the characters 7. This can be done using an embossing machine onto which the punches and matrices have previously been placed according to how the license to be made is composed, so as to simultaneously emboss all the characters 7 onto base plate 3.

Once base plate 3 is embossed, each embossed area is colored by painting or inking via heat transfer, so as to form coating 8 for each character 7.

In the second embodiment represented in FIG. 2, the marking plate 11 is a double-type license plate, comprising a base plate 13 and a thin surface or covering plate 15 that are joined together. Plate 11 carries license characters 17, obtained by stamping plate 11 using sets of punches and matrices that complement the shape of each of the characters 17.

Base plate 15 is the visible background of license plate 11 and is provided with a background coating 16 for the plate, such as a lacquer or a retro-reflective film. Furthermore, base plate 13 is provided with a coating 14 having different nature and color than coating 16, such as a lacquer. Coatings 14 and 16 have photometric and colorimetric characteristics that comply with the regulations.

Base plate 13 is composed of a composite material containing a synthetic, artificial or natural matrix 131 and a fiber reinforcement 133 comprising natural fibers. In the example described, base plate 13 is composed of polypropylene loaded with 30% sisal fibers, with dimensions that are in accordance with the regulations, and a plate thickness of 1 mm. More generally, base plate 13 can have a thickness ranging between 0.6 mm and 5 mm, preferably of the order of 1 mm.

Thin plate 15 is composed of a composite material containing a synthetic or natural matrix 151 and fiber reinforcement 153 comprising natural fibers. In the example described, thin plate 15 is composed of polypropylene loaded with sisal fibers, with dimensions analogous to base plate 13 and a plate thickness of 0.2 mm. More generally, thin plate 15 can have a thickness ranging between about 0.05 mm and 0.6 mm, preferably of the order of 0.2 mm.

Alternatively, the composite materials composing base plate 13 and thin plate 15 can have different kinds of matrices and fiber reinforcements. Additionally, thin plate 15 can be composed of a composite material that does not contain natural fibers, even of a metal, such as aluminum. As in the previous embodiment, the matrix of composite material for base plate 13 and, if need be, thin plate 15, can be any type of synthetic, artificial or natural resin. The fiber reinforcement for the composite materials can also comprise any type of natural fiber, optionally in combination with synthetic fibers.

The mechanical characteristics of the materials composing respectively base plate 13 and thin plate 15 are adapted to obtain optimal stamping quality for characters 17. In particular, the elongation coefficient of thin plate 15 is much lower than the elongation coefficient for base plate 13. Accordingly, cutting thin plate 15 during stamping plate 11 is sharp and the gripping of base plate 13 onto the surface of thin plate 15 is effective. This guarantees the marking quality of characters 17, in particular in terms of the legibility and mechanical hold of the characters. Advantageously, the materials composing base plate 13 and thin plate 15 permit stamping of plate 11 using tools normally used to manufacture double-type aluminum license plates.

A process for manufacturing license plate 11 in accordance with the second embodiment comprises the following steps:

First, a draft for base plate 13 and a draft for thin plate 15 are prepared, in an analogous manner to the preparation of the draft for base plate 3 of the first embodiment. A rigid base plate draft having thickness of 1 mm and a rigid thin plate draft having thickness of 0.2 mm are thereby obtained.

Base plate 13 is then cut out of the base plate draft and thin plate 15 from the thin plate draft, at the lengths and widths desired for license plate 11, and the edges of each plate 13 and 15 are shaped using the current practices for manufacturing double-type license plates. Next thin plate 15 is coated with background coating 16 for license plate 11. Base plate 13 is also coated 13 with corresponding coating 14. Alternatively, coatings 14 and 16 can be affixed respectively onto the base plate draft and the thin plate draft before cutting out one or more base plates or thin plates from the corresponding draft.

Base plate 13 is then joined to thin plate 15, for example using a peal-off adhesive strip placed between the two plates. Alternatively, base plate 13 and thin plate 15 can be joined by other means, in particular by gripping the edges of the two plates. Marking plate 11 is then stamped using a set of punches and matrices that complement the shape of each of the license characters 17. For that purpose, a stamping machine can be used, onto which the punches and matrices have previously been placed according to the composition of the license to be made. Once plate 11 is stamped, the cut-outs are separated and removed from thin plate 15.

In a conventional way, some of the steps of manufacturing processes described herein before are performed at the manufacturing sites of the plates, and some of the steps are performed on the site where the licenses are installed, for example at a car dealership.

As is seen from the embodiments described previously, a marking plate in accordance with the present disclosure delivers improved symbol embossing or stamping quality, along with a limited manufacturing cost because of the lower cost of its component material or materials, in particular in terms of manufacture, storage, transport, etc. Indeed, composite materials containing a synthetic or natural matrix loaded with natural fibers have lower density than aluminum and are consequently relatively inexpensive, and in particular less expensive than aluminum, for equal masses.

Additionally, due to the at least partially natural nature of its component composite material or materials, a marking plate in accordance with the present disclosure has good recyclability and biodegradability, which has advantages in the treatment of used plates.

Finally, through suitable selection of a component material or materials, a marking plate in accordance with the present disclosure can be manufactured using tools for manufacturing traditional aluminum marking plates. Accordingly, manufacturing marking plates in accordance with the present disclosure does not require development of new cutting, assembly, embossing, or stamping tools.

The scope of the present disclosure is not limited to the examples described and represented. In particular, the description above was described for a vehicle license plate. It can however be transposed to any type of marking plate comprising symbols obtained by stamping the plate, such as for example vertical information signs, road or advertising signs, number plates and street signs, or others.

1. A marking plate, comprising:
at least one base plate including a matrix of a composite material and a fiber reinforcement including natural fibers; and
symbols on the marking plate;
wherein the marking plate is one of a license plate and a signage plate.

2. The marking of claim 1, wherein the matrix of composite material includes at least one of a thermoplastic resin and a thermohardening resin.

3. The marking plate of claim 1, wherein the matrix of composite material includes at least one of a polyester resin, an epoxy resin, or a phenolic resin.

4. The marking plate of claim 1, wherein the fiber reinforcement includes at least one of sisal, hemp, linen, jute, wood, cotton, broom, and raffia fibers.

5. The marking plate of claim 1, wherein the matrix includes propylene and the fiber reinforcement includes sisal fibers.

6. The marking plate of claim 1, wherein the marking plate is a single-type plate, the base plate including a coating, and the symbols are formed by stamping the base plate and coloring the stamped areas.

7. The marking plate of claim 1, wherein the marking plate is a double-type plate and comprises a thin surface plate that joins together with the base plate, the thin plate being provided with a coating for the marking plate background, and the symbols are formed by stamping the marking plate and removing the cut-outs from the thin plate.

8. The marking plate of claim 7, wherein the thin plate includes a composite material containing a matrix and a fiber reinforcement comprising natural fibers.

9. The marking plate of claim 8, wherein the thin plate is composed of a composite material containing the same kind of matrix and natural fibers as the composite material composing the base plate, so that an elongation coefficient of the thin plate is less that an elongation coefficient of the base plate.

10. The use of at least one composite material containing a matrix and a fiber reinforcement comprising natural fibers for manufacturing a marking plate of claim 1.

11. A process of manufacturing the marking plate of claim 6, comprising:
forming a base plate draft formed from the fiber reinforcement and the matrix of composite material;
cutting a base plate out of the base plate draft;
coating the base plate or the base plate with a background coating;
stamping the base plate.

12. A process of manufacturing the marking plate of claim 7, comprising:
preparing a base plate draft is prepared from the fiber reinforcement and the matrix;
preparing a thin plate draft from the fiber reinforcement and the matrix that compose the thin plate;
cutting the base plate out of the base plate draft;
cutting the thin plate out of the thin plate draft;
coating the thin plate draft or the thin plate with a background coating;
coating the base plate draft or the base plate with a coating;
joining together the base plate and the thin plate;
stamping the marking plate; and removing the cut-outs from the thin plate.
